(19) United States
(12) Patent Application Publication
(10) Pub. No.: US 2025/0137216 A1
(43) Pub. Date: May 1, 2025

(54) SHIP AUXILIARY BERTHING DEVICE

(71) Applicant: Jiangsu University of Science and Technology, Zhenjiang (CN)

(72) Inventors: Junliang GAO, Zhenjiang (CN); Chenglong MI, Zhenjiang (CN); Linhui HOU, Zhenjiang (CN); Zhiwei SONG, Zhenjiang (CN)

(21) Appl. No.: 18/746,206

(22) Filed: Jun. 18, 2024

(30) Foreign Application Priority Data
Oct. 31, 2023 (CN) 2023114369364

(51) Int. Cl. E02B 3/26

(52) U.S. Cl. CPC E02B 3/26

(57) ABSTRACT

The disclosure belongs to a technical field of ship berthing equipment, and in particular to a ship auxiliary berthing device, specifically including: a first auxiliary component, a second auxiliary component and a third auxiliary component connected in sequence, the third auxiliary component is connected with a harbor shore, the first auxiliary component is abutted with the ship, and the first auxiliary component, the second auxiliary component and the third auxiliary component are all used for buffering and berthing the ship; the first auxiliary component includes an arc-shaped rod sliding in an arc shape, two ends of the arc-shaped rod are provided with buffering parts, the arc-shaped rod is arranged on a vertical plane, and the arc-shaped rod is concave to the ship.

### TECHNICAL FIELD

The disclosure belongs to a technical field of ship berthing equipment, and in particular to a ship auxiliary berthing device.

### BACKGROUND

Ships generate impact energy when berthing, therefore, the ship auxiliary berthing device in harbor shores is a very imharbor shoreant part of harbor shore design. Ship auxiliary berthing device can not only ensure the safety of ship berthing, but also prolong the harbor shore service life and reduce the maintenance cost.

Spring energy absorbing buffers or elastic buffering pads or those discarded rubber wheels are used in most of the existing ship auxiliary mooring devices. These methods absorb impact energy in a single way, and all of them convert impact energy into elastic potential energy. Once there is too much impact energy, these devices will fail in operation and the components must be replaced, which is impractical and has poor anti-collision performance.

### SUMMARY

In order to solve the above technical problems, the present disclosure provides a ship auxiliary berthing device.

In order to achieve the purpose of the disclosure, the technical scheme adopted by the disclosure is as follows: the ship auxiliary berthing device includes a first auxiliary component, a second auxiliary component and a third auxiliary component connected in sequence, where the third auxiliary component is connected with a harbor shore and the first auxiliary component is abutted with a ship, and the first auxiliary component, the second auxiliary component and the third auxiliary component are all used for buffering and berthing the ship; the first auxiliary component includes an arc-shaped rod capable of making arc sliding, two ends of the arc-shaped rod are provided with buffering parts, the arc-shaped rod is arranged on a vertical plane, and the arc-shaped rod is concave to the ship; during operation, the upper part of the ship first contacts with the buffering part at the upper part, and the arc-shaped rod slides, and then the lower part of the ship contacts with the buffering part at the lower part. The first auxiliary component extrudes the second auxiliary component, and the second auxiliary component extrudes the third auxiliary component.

Optionally, the first auxiliary component further includes an arc-shaped sleeve connected with the second auxiliary component, the arc-shaped rod is slidably arranged in the arc-shaped sleeve, and both ends of the arc-shaped rod extend out of the arc-shaped sleeve; in the initial state, the two buffering parts are located in the same vertical direction, and the arc-shaped sleeve is located in the middle of the arc-shaped rod; first springs are sleeved on a periphery of the arc-shaped rod, one ends of the first springs are fixedly connected with the buffering parts, and the other ends of the first springs are fixedly connected with one end of the arc-shaped sleeve.

Optionally, the inner side wall of the arc-shaped sleeve is provided with an arc-shaped chute along the axial direction thereof, and the periphery of the arc-shaped rod is provided with a slider corresponding to the arc-shaped chute.

Optionally, the second auxiliary component includes an annular sleeve, the inside of the annular sleeve is slidably provided with a matched arc-shaped block and a pouring weight, the arc-shaped block and the pouring weight are arranged at intervals, and the space in-between is filled with hydraulic oil; the periphery of the arc-shaped block is provided with first gear teeth, and the periphery of the arc-shaped rod is provided with second gear teeth meshed with the first gear teeth.

Optionally, openings are arranged outside the arc-shaped sleeve and outside the annular sleeve, and the two openings correspond to each other; a barrier block is fixedly arranged in the annular sleeve, the arc-shaped block and the pouring weight are respectively arranged on both sides of the barrier block in the annular sleeve, and a sealing piston is arranged at one end of the arc-shaped block far from the barrier block; the pouring weight is arranged in the annular sleeve between the barrier block and the sealing piston, and both ends of the pouring weight are filled with the hydraulic oil.

Optionally, the barrier block is fixedly arranged at the upper part in the annular sleeve, and in the initial state, the pouring weight is located at the inner bottom of the annular sleeve.

Optionally, the third auxiliary component includes a buffering box, a sliding groove with an opening facing the second auxiliary component is arranged on the buffering box, a second spring is fixedly arranged in the sliding groove, a sliding buffer block adapted to the sliding groove is fixedly arranged at the other end of the second spring, and one end of the sliding buffer block far away from the second spring is connected with the second auxiliary component.

Optionally, one end of the sliding buffer block far from the second auxiliary component is provided with an elastic pad, and the other end of the elastic pad is fixedly connected with the second spring; one end of the sliding buffer block close to the second auxiliary component is provided with an annular opening adapted to the periphery of the annular sleeve, and the sliding buffer block is fixedly connected with the annular sleeve.

Optionally, the buffering part includes a connecting plate fixedly connected with the arc-shaped rod, the other end of the connecting plate is fixedly provided with a bag filled with hydraulic oil, and a contact part of the bag and the ship is provided with a buffering pad.

Optionally, the buffering box is provided with a flow channel, one end of the flow channel is communicated with the bottom of the sliding groove, and the other end of the flow channel is communicated with the bag through a connecting hose.

The disclosure has following beneficial effects:

According to the disclosure, the first auxiliary component, the second auxiliary component and the third auxiliary component are arranged, the third auxiliary component is fixedly connected with the harbor shore, the first auxiliary component is abutted with the ship, and the first auxiliary component, the second auxiliary component and the third auxiliary component are all used for buffering and berthing the ship; the first auxiliary component includes an arc-shaped rod capable of making arc sliding, two ends of the arc-shaped rod are provided with buffering parts, the arc-shaped rod is arranged on a vertical plane, and the arc-shaped rod is concavely arranged towards the ship; during operation, the upper part of the ship first contacts with the buffering part at the upper part, and the arc-shaped rod slides, and then the lower part of the ship contacts with the buffering part at the lower part. The first auxiliary component extrudes the second auxiliary component, and the second auxiliary component extrudes the third auxiliary component. The first auxiliary component, the second auxiliary component and the third auxiliary component will form three-stage stepped extrusion, thereby prolonging the service life. The working principle of the first auxiliary component of the disclosure fully considers the wedge shape of the ship, and the ship is buffered by this point, so that the thrust of the ship to the two buffering parts can be partially offset.

### BRIEF DESCRIPTION OF THE DRAWINGS

FIG. 1 is a schematic diagram of the overall structure of an auxiliary berthing device according to the present disclosure (Initial state of the device).

FIG. 2 is a partial schematic view of a structure A in FIG. 1.

FIG. 3 is a schematic diagram of the overall structure of the auxiliary berthing device according to the present disclosure (the first and second auxiliary components are in working condition state).

FIG. 4 is a partial schematic view of a structure B in FIG. 3.

FIG. 5 is a schematic diagram of the overall structure of the auxiliary berthing device according to the present disclosure (all three auxiliary components are in working state).

In the figures: harbor shore 1; ship 2; buffering part 3; arc-shaped rod 4; first spring 5; connecting hose 6; sliding buffer block 7; sliding groove 8; second spring 9; elastic pad 10; buffering box 11; flow channel 12; arc-shaped sleeve 13; arc-shaped block 14; arc-shaped chute 5; slider 16; second gear teeth 17; first annular limiting block 18; first gear teeth 19; hydraulic oil 20; sealing piston 21; pouring weight 23; annular sleeve 24; barrier block 25.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiment of the disclosure, but not the whole embodiment. Unless otherwise specified, the technical means used in the embodiments are conventional means well known to those skilled in the art.

In the description of the disclosure, it is to be understood that the orientation or position relationships indicated by the terms “longitudinal”, “lateral”, “up”, “down”, “front”, “back”, “left”, “right”, “vertical”, “horizontal”, “top”, “bottom”, “inside”, “outside”, etc., are based on the orientation or position relationships shown in the attached drawings and are intended only to facilitate the description of the disclosure. It is not indicated or implied that the device or element referred to must have a particular orientation, be constructed and operated in a particular orientation, and therefore cannot be construed as a limitation of the present disclosure.

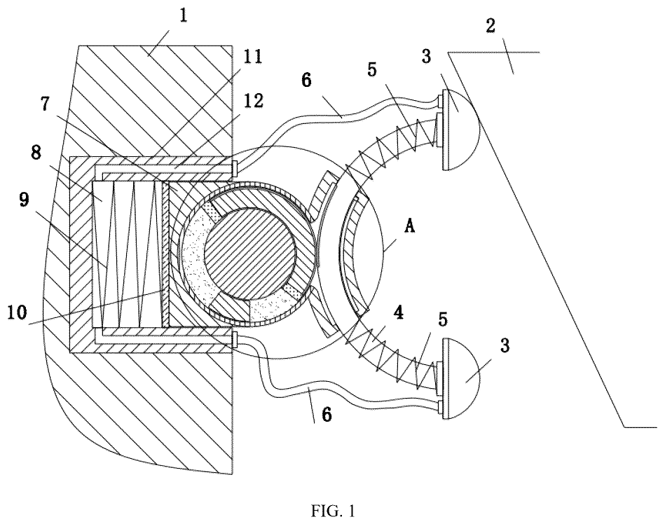

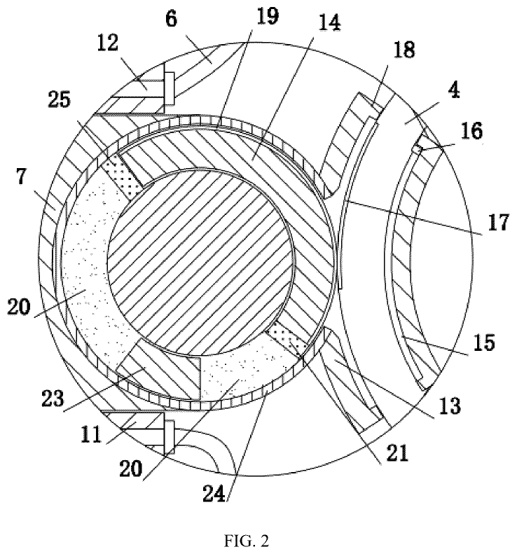

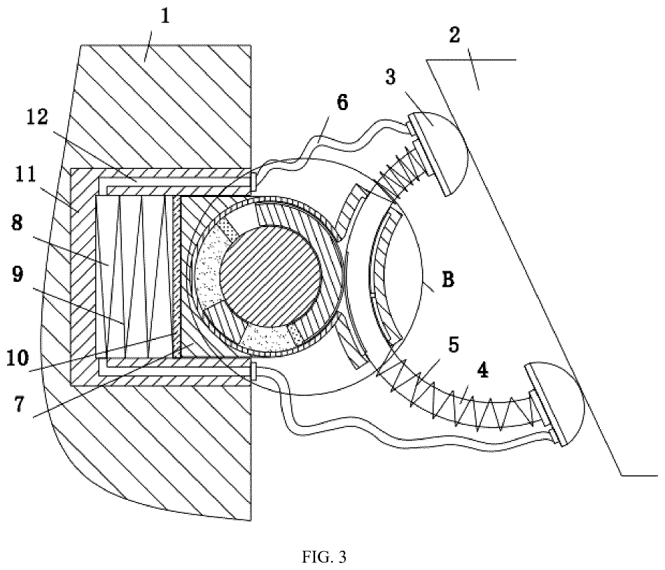

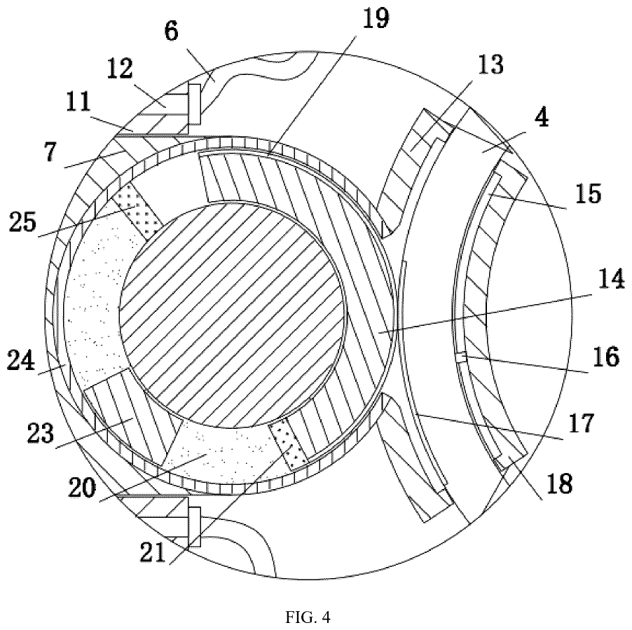

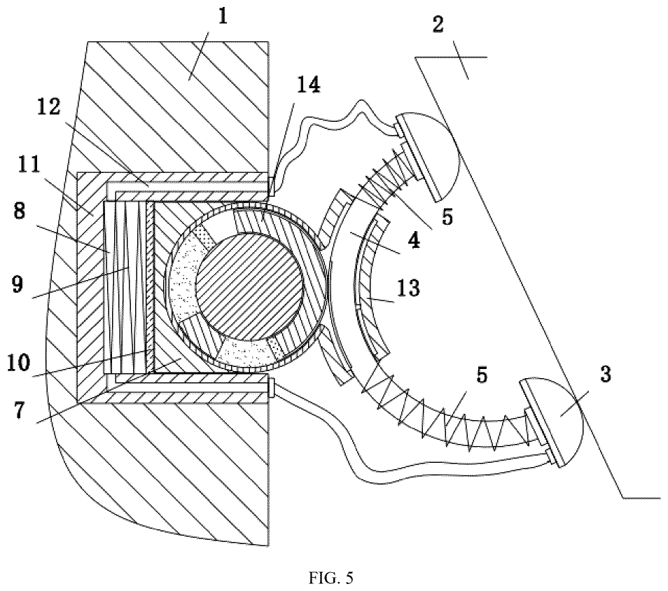

As shown in FIG. 1-FIG. 5, the disclosure discloses a ship auxiliary berthing device, including a first auxiliary component, a second auxiliary component and a third auxiliary component connected in sequence, where the third auxiliary component is fixedly connected with a harbor shore 1, the first auxiliary component is abutted with a ship 2, and the first auxiliary component, the second auxiliary component and the third auxiliary component are all used for buffering and berthing the ship 2. When the ship 2 comes to the harbor shore to dock, its hull contacts with the first auxiliary component and extrudes the first auxiliary component, and the first auxiliary component continues to extrude the second auxiliary component, and the second auxiliary component extrudes the third auxiliary component. The three-stage buffer berthing will not only make the ship 2 dock safely, but also make the first auxiliary component, the second auxiliary component and the third auxiliary component excessively extrude, which will lead to the reduction of service life. It should be noted that the first auxiliary component, the second auxiliary component and the third auxiliary component may be conventional buffer structures.

An optional embodiment of the first auxiliary component is as follows: the first auxiliary component includes an arc-shaped rod 4 capable of making arc sliding, the sliding direction of the arc-shaped rod 4 is consistent with the direction of its central axis, and the two ends of the arc-shaped rod 4 are fixedly provided with buffering parts 3. It should be noted that the arc-shaped rod 4 is arranged on the vertical plane, and the arc-shaped rod 4 is concave to the ship 2, that is, during operation, the two buffering parts 3 contact with the hull, and the convex part of the arc-shaped rod 4. During operation, when the ship 2 comes to the harbor shore, the upper part of the ship 2 first contacts with the buffering part 3 at the upper part, and the arc-shaped rod 4 slides along its arc trajectory, and then the lower part of the ship 2 contacts with the buffering part 3 at the lower part. The extruding force of the upper part of the ship 2 on the buffer part 3 at the upper part is transmitted to the buffer part 3 at the lower part, and the buffer part 3 at the lower part presses the lower part of the ship 2. At this time, the two buffering parts 3 are in contact with the hull, and the extruding force of the ship 2 on the two buffering parts 3 can offset part of each other, and then the arc-shaped rod 4 extrudes the second auxiliary component.

Further, the first auxiliary component also includes an arc-shaped sleeve 13 fixedly connected with the second auxiliary component, and the arc-shaped rod 4 is slidably arranged in the arc-shaped sleeve 13, and both ends of the arc-shaped rod 4 extend out of the arc-shaped sleeve 13, that is, the arc length of the arc-shaped rod 4 is longer than the arc length of the arc-shaped sleeve 13. The peripheral shape of the arc-shaped rod 4 is adapted to the shape of the inner cavity of the arc-shaped sleeve 13. In the initial state, the two buffering parts 3 are located in the same vertical direction and the arc-shaped sleeve 13 is located in the middle of the arc-shaped rod 4.

It should be noted that in order to limit the sliding position of the arc-shaped rod 4 in the arc-shaped sleeve 13, first annular limiting blocks 18 are arranged at both ends of the arc-shaped sleeve 13, and second annular limiting blocks corresponding to the first annular limiting blocks 18 are fixedly arranged on the outer side wall of the arc-shaped rod 4 near the buffering part 3 at the upper part.

First springs 5 are sleeved on the periphery of the arc-shaped rod 4, and one ends of the first springs 5 are fixedly connected with the buffering parts 3, and the other ends are fixedly connected with one end of the arc-shaped sleeve 13. Specifically, the number of the first springs 5 is two, and the two springs are respectively arranged at both ends of the arc-shaped rod 4. In the initial state, the first spring 5 fixedly connected with the buffering part 3 at the upper part is in a compressed state, and the first spring 5 fixedly connected with the buffering part 3 at the lower part is in an extended state, so that the arc-shaped sleeve 13 is located in the middle of the arc-shaped rod 4, and the two buffering parts 3 are located on the same vertical line.

Further, in order to limit the sliding trajectory of the arc-shaped rod 4, an arc-shaped chute 15 is arranged on the inner side wall of the arc-shaped sleeve 13 along its axis direction; the periphery of the arc-shaped rod 4 is provided with a slider 16 corresponding to the arc-shaped chute 15, thereby limiting the relative position of the arc-shaped sleeve 13 and the arc-shaped chute 15 in the radial direction.

An optional embodiment of the second auxiliary component: the second auxiliary component includes an annular sleeve 24, and the inside of the annular sleeve 24 is slidably provided with a matched arc-shaped block 14 and a pouring weight 23, and the arc-shaped block 14 and the pouring weight 23 can move in an arc shape in the annular cavity of the annular sleeve 24, and the arc-shaped block 14 and the pouring weight 23 are arranged at intervals. The space between the arc-shaped block 14 and the pouring weight 23 in the annular cavity is filled with hydraulic oil 20, the periphery of the arc-shaped block 14 is provided with first gear teeth 19, and the periphery of the arc-shaped rod 4 is provided with second gear teeth 17 meshed with the first gear teeth 19. During operation, the arc-shaped rod 4 slides in the arc-shaped sleeve 13, and the first gear teeth 19 are matched with the second gear teeth 17. The arc-shaped rod 4 drives the arc-shaped block 14 to move arcuately in the cavity in the annular sleeve 24, and the arc-shaped block 14 extrudes the hydraulic oil 20 and pushes the pouring weight 23 to move arcuately in the cavity in the annular sleeve 24, where the thrust of the ship 2 on the first auxiliary component is converted into the internal energy of the hydraulic oil 20, and the pouring weight 23 is pushed to move to do work and do work against gravity. Compared with the conventional spring buffering work, a large impact force is converted into various forms and small amount of work, and then they are consumed, so that the service life of each component can be prolonged, and the component will not fail due to too much force, and the structure is simpler.

Further, openings are arranged outside the arc-shaped sleeve 13 and outside the annular sleeve 24, and the two openings correspond to each other, and the meshing parts of the first gear teeth 19 and the second gear teeth 17 are arranged at the two openings; a barrier block 25 is fixedly arranged in the inner cavity of the annular sleeve 24, the arc-shaped block 14 and the pouring weight 23 are respectively arranged in the annular sleeve 24 at both sides of the barrier block 25, and a sealing piston 21 is arranged at one end of the arc-shaped block 14 far away from the barrier block 25, so that the hydraulic oil 20 can be prevented from entering the area where the arc-shaped block 14 is located. The pouring weight 23 is arranged in the annular sleeve 24 between the barrier block 25 and the sealing piston 21, and both ends of the pouring weight 23 are filled with the hydraulic oil 20. During operation, the arc-shaped block 14 extrudes the hydraulic oil 20 first, and then pushes the pouring weight 23; when the pouring weight 23 moves, it extrudes the hydraulic oil 20 at the other end again. The hydraulic oil 20 on this side will not enter the area where the arc-shaped block 14 is located because of the barrier block 25. Even in the initial state, the hydraulic oil 20 will not enter the arc-shaped sleeve 13 through the opening due to the length of the arc-shaped block 14.

It should be noted that, in order to make the buffering effect better, the pouring weight 23 should be made of a metal block with higher density, and the outside of the pouring weight 23 should be made as rough as possible, so that the friction between the pouring weight 23 and the inner side wall of the arc-shaped sleeve 13 is greater, and more thrust is required to push the pouring weight 23 to move.

In an optional technical scheme, the barrier block 25 is fixedly arranged at the upper part in the annular sleeve 24, and the pouring weight 23 is located at the bottom of the annular sleeve 24 in the initial state. During operation, the arc-shaped block 14 needs to lift the pouring weight 23 from the lower part of the inner cavity of the arc-shaped sleeve 13 to the higher part of the inner cavity of the arc-shaped sleeve 13, so as to convert the thrust work into the gravity work.

An optional embodiment of the third auxiliary component: the third auxiliary component includes a buffering box 11 embedded in the harbor shore 1, and the buffering box 11 is provided with a sliding groove 8 with an opening facing the second auxiliary component. A second spring 9 is fixedly arranged in the sliding groove 8, and a sliding buffer block 7 adapted to the sliding groove 8 is fixedly arranged at the other end of the second spring 9, and an end of the sliding buffer block 7 far from the second spring 9 is fixedly connected with the second auxiliary component. The second auxiliary component extrudes the sliding buffer block 7, and the sliding buffer block 7 squeezes the second spring 9.

Further, one end of the sliding buffer block 7 far from the second auxiliary component is fixedly connected with an elastic pad 10 with sealing performance, and the other end of the elastic pad 10 is fixedly connected with the second spring 9; one end of the sliding buffer block 7 close to the second auxiliary component is provided with an annular opening adapted to the periphery of the annular sleeve 24, a part of the sliding buffer block 7 is arranged in the annular opening, and the sliding buffer block 7 is fixedly connected with the annular sleeve 24. It should be noted that the outer diameter of the annular sleeve 24 is smaller than the width of the sliding buffer block 7, so that the annular sleeve 24 can also be retracted into the sliding groove 8 during operation.

Further, the buffering part 3 includes a connecting plate fixedly connected with the arc-shaped rod 4, and a bag filled with hydraulic oil 20 is fixedly arranged at the other end of the connecting plate, and a buffering pad is arranged at the contact part between the bag and the ship 2. The buffering box 11 is provided with a flow channel 12, one end of the flow channel 12 is communicated with the bottom of the sliding groove 8, and the other end of the flow channel 12 is communicated with the bag through a connecting hose 6. The connecting hose 6 is a metal connecting hose 6. The shape of the bag can be changed. During operation, the ship 2 extrudes the buffering pad, and the hydraulic oil 20 in the bag is extruded into the sliding groove 8, so that the hydraulic oil 20 in the sliding groove 8 is increased, and the sliding buffer block 7 is pushed, so that the extruding force of the ship 2 on the buffering part 3 is converted into the thrust of the first auxiliary component in the opposite direction on the ship 2.

By arranging the first auxiliary component, the second auxiliary component and the third auxiliary component, the auxiliary berthing device of the disclosure carries out three-stage buffering docking, converts the thrust of the ship 2 to the first auxiliary component into the internal energy of hydraulic oil 20, pushes the weight 23 to move to do work, and the pouring weight 23 does work against gravity, etc. Compared with the conventional spring buffering and elastic block buffering, a large impact force is converted into works in various forms and a small amount to be consumed. Therefore, the service life of each component is capable of being prolonged, and the components do not fail due to too much force, and the structure is simpler, and at the same time, sudden large impact force is capable of being avoided.

The above-mentioned embodiments only describe the preferred mode of the disclosure, and do not limit the scope of the disclosure. Under the premise of not departing from the design spirit of the disclosure, all kinds of deformation, variation, modification and substitution of the technical scheme of the disclosure made by ordinary technicians in the field shall fall within the protection scope determined by the claims of the disclosure.

What is claimed is:

1. A ship auxiliary berthing device, comprising a first auxiliary component, a second auxiliary component and a third auxiliary component connected in sequence, wherein the third auxiliary component is connected with a harbor shore, the first auxiliary component is abutted with a ship (2), and the first auxiliary component, the second auxiliary component and the third auxiliary component are all used for buffering and berthing the ship (2); the first auxiliary component comprises an arc-shaped rod (4) capable of making arc sliding, two ends of the arc-shaped rod (4) are provided with buffering parts (3), the arc-shaped rod (4) is arranged on a vertical plane, and the arc-shaped rod (4) is concave to the ship (2); during operation, the upper part of the ship (2) first contacts with the buffering part (3) at the upper part, the arc-shaped rod (4) slides, and then the lower part of the ship (2) contacts with the buffering part (3) at the lower part, the first auxiliary component extrudes the second auxiliary component, and the second auxiliary component extrudes the third auxiliary component.

2. The ship auxiliary berthing device according to claim 1, wherein the first auxiliary component further comprises an arc-shaped sleeve (13) connected with the second auxiliary component, the arc-shaped rod (4) is slidably arranged in the arc-shaped sleeve (13), and both ends of the arc-shaped rod (4) extend out of the arc-shaped sleeve (13); in the initial state, the two buffering parts (3) are located in the same vertical direction, and the arc-shaped sleeve (13) is located in the middle of the arc-shaped rod (4); first springs (5) are sleeved on a periphery of the arc-shaped rod (4), one ends of the first springs (5) are fixedly connected with the buffering parts (3), and the other ends are fixedly connected with one end of the arc-shaped sleeve (13).

3. The ship auxiliary berthing device according to claim 2, wherein an arc-shaped chute (15) is arranged on the inner side wall of the arc-shaped sleeve (13) along the axial direction thereof, and a slider (16) corresponding to the arc-shaped chute (15) is arranged on the periphery of the arc-shaped rod (4).

4. The ship auxiliary berthing device according to claim 2, wherein the second auxiliary component comprises an annular sleeve (24), the inside of the annular sleeve (24) is slidably provided with a matched arc-shaped block (14) and a pouring weight (23), the arc-shaped block (14) and the pouring weight (23) are arranged at intervals, and a space in-between is filled with hydraulic oil (20); the periphery of the arc-shaped block (14) is provided with first gear teeth (19), and the periphery of the arc-shaped rod (4) is provided with second gear teeth (17) meshed with the first gear teeth (19).

5. The ship auxiliary berthing device according to claim 4, wherein openings are arranged outside the arc-shaped sleeve (13) and outside the annular sleeve (24), and the two openings correspond to each other; a barrier block (25) is fixedly arranged in the annular sleeve (24), the arc-shaped block (14) and the pouring weight block (23) are respectively arranged on both sides of the barrier block (25) in the annular sleeve (24), and a sealing piston (21) is arranged at one end of the arc-shaped block (14) far from the barrier block (25); the pouring weight (23) is arranged in the annular sleeve (24) and between the barrier block (25) and the sealing piston (21), and both ends of the pouring weight (23) are filled with the hydraulic oil (20).

6. The ship auxiliary berthing device according to claim 5, wherein the barrier block (25) is fixedly arranged at the upper part in the annular sleeve (24), and in the initial state, the pouring weight (23) is located at the inner bottom of the annular sleeve (24).

7. The ship auxiliary berthing device according to claim 6, wherein the third auxiliary component comprises a buffering box (11), and a sliding groove (8) with an opening facing the second auxiliary component is arranged on the buffering box (11), and a second spring (9) is fixedly arranged in the sliding groove (8), a sliding buffer block (7) adapted to the sliding groove (8) is fixedly arranged at the other end of the second spring (9), and one end of the sliding buffer block (7) far away from the second spring (9) is connected with the second auxiliary component.

8. The ship auxiliary berthing device according to claim 7, wherein one end of the sliding buffer block (7) far from the second auxiliary component is provided with an elastic pad (10), and the other end of the elastic pad (10) is fixedly connected with the second spring (9); one end of the sliding buffer block (7) close to the second auxiliary component is provided with an annular opening adapted to the periphery of the annular sleeve (24), and the sliding buffer block (7) is fixedly connected with the annular sleeve (24).

9. The ship auxiliary berthing device according to claim 8, wherein the buffering part (3) comprises a connecting plate fixedly connected with the arc-shaped rod (4), and the other end of the connecting plate is fixedly provided with a bag filled with hydraulic oil, and a contact part of the bag and the ship (2) is provided with a buffering pad.

10. The ship auxiliary berthing device according to claim 9, wherein the buffering box (11) is provided with a flow channel (12), and one end of the flow channel (12) is communicated with the bottom of the sliding groove (8), and the other end is communicated with the bag through a connecting hose (6).
